(19) United States
(12) Patent Application Publication
(10) Pub. No.: US 2007/0056613 A1
(43) Pub. Date: Mar. 15, 2007

(54) Dishwasher comprising a circulating pump

(75) Inventors: Andreas Haas, Bielefeld (DE); Jens Laghusemann, Bad Salzuflen (DE)

Correspondence Address: DARBY & DARBY P.C., P. O. BOX 5257, NEW YORK, NY, 10150-5257, US

(73) Assignee: Miele & Cie. KG, Gutersloh (DE)

(21) Appl. No.: 10/596,016

(22) PCT Filed: Nov. 15, 2004
(86) PCT No.: PCT/EP04/12926

§ 371 Date: May 25, 2006

(30) Foreign Application Priority Data
Nov. 25, 2003 (DE) 103 55 343.6

(51) Int. Cl. B08B 3/00

(52) U.S. Cl. 134/103.2

(57) ABSTRACT

A dishwasher includes a circulating jump, a spraying system and a spray nozzle enabling device. The spraying system is disposed in a spray chamber and includes a first and a second group of spray nozzles, the first and second group of spray nozzles being disposed on a rotatable nozzle arm. The first and second group of spray nozzles are capable of being operated independently by wash water flowing therethrough. The spray nozzle enabling device is disposed in an area of the nozzle arm and configured to enable, for the wash water, alternately either the first or the second group of spray nozzles in a random manner and independently of a control system associated with the spraying system.

### CROSS-REFERENCE TO PRIOR APPLICATION

The above-referenced application is the U.S. National Phase of International Patent Application PCT/EP2004/012926, filed Nov. 15, 2004, which claims priority from German Application No. 103 55 343.6, filed Nov. 25, 2003, which is incorporated by reference herein. The International application was published in German on Jun. 30, 2005 as WO 2005/058123 A1.

### BACKGROUND

The present invention relates to a dishwasher comprising a circulating pump and at least one spraying system provided in the wash chamber and having at least two groups of spray nozzles provided on a rotatably mounted nozzle arm, said groups of spray nozzles being able to be operated independently by fluid flowing through them.

Spraying systems intended for use in dishwashers and having nozzle arms provided with channels which are arranged separately from each other and are respectively equipped with nozzle openings are sufficiently known from the prior art. The nozzles associated with a channel are also referred to as a group of spray nozzles. For example, German publication DE 38 16 408 describes a spray nozzle system having a nozzle arm on which are arranged different groups of spray nozzles which can be independently supplied with wash water via a freely selectable diverting device. This makes it possible to control the action of the jet and/or the direction of rotation of the nozzle arm. The control is performed in a freely selectable sequence by the diverting device, which is in communication with the different groups via separate supply lines accordingly. Another embodiment for controlling groups of spray nozzles is known from German publication DE 696 18 563, where the individual groups in the nozzle arm are, in fact, also controlled by a freely selectable diverting device. However, in accordance with the method described there, two feed pumps are provided, which are operated independently of each other for supply to the first distributor or the second distributor, also via separate lines.

In this prior art method of controlling groups of spray nozzles arranged on a nozzle arm, it is considered disadvantageous that the known embodiments merely allow the individual groups to be controlled only via separate supply lines using additional pumps or freely selectable diverting devices.

### SUMMARY OF THE INVENTION

It is, therefore, an object of the present invention to provide an inexpensive and simple switching device which can be used to enable the flow path to one or the other group of spray nozzles.

The present invention provides a dishwasher including a circulating pump, a spraying system and a spray nozzle enabling device. The spraying system is disposed in a spray chamber and includes a first and a second group of spray nozzles, the first and second group of spray nozzles being disposed on a rotatable nozzle arm. The first and second group of spray nozzles are capable of being operated independently by wash water flowing therethrough. The spray nozzle enabling device is disposed in an area of the nozzle arm and configured to enable, for the wash water, alternately either the first or the second group of spray nozzles in a random manner and independently of a control system associated with the spraying system.

A means which enables either one or the other group of spray nozzles of a nozzle arm for the wash water in a random manner and independently of the control system is disposed in the area of the nozzle arm, thereby providing that sub-areas of the spray arm are supplied with wash water at random. Thus, the volume flow available is passed through a small number of nozzles, resulting in an increase in the spray jet height at the individual nozzles. In addition, due to the distribution of the volume flow, the total amount of circulated water is smaller, which saves water. The means that arbitrarily controls the volume flow of the wash water is advantageously disposed in the axis of rotation of the nozzle arm and, more precisely, in the wash water supply conduit. This design eliminates the need for additional supply paths or means for supplying wash water to the individual groups of spray nozzles. In addition, a design of this type does not need a diverting device or any additional pumps to be accommodated in the housing.

In order to enable one or the other group of spray nozzles, the means, as such, assumes different positions, either as a result of the pressure of the wash water and/or the rotation of the nozzle arm. The means advantageously includes a ball disposed in a chamber-like cage through which flows wash water. The groups of spray nozzles interact with the chamber-like cage separately and such that the volume flow is passed through either the right or left side of the chamber. The chamber-like cage is provided with a depression at its center. A first and second restricted translational guide path for the ball are adjacent to the depression on both sides, respectively. This allows the first guide path to be in communication with one group of spray nozzles and the second guide path to be in communication with the other group of spray nozzles, respectively. Due to the arbitrary position of the ball, the channel on the opposite side is enabled, respectively, so that the volume flow passes into the respective sub-area of the arm. For reasons of balance, the sub-areas are designed such that the flow is through either the inner or the outer area.

Since the washing alternates between the upper/lower level and the middle level, the washing is interrupted at regular intervals in the middle space of the wash chamber when no volume flow is available. Then, the ball returns to the slightly lower depression in the chamber-like cage. When switching between the wash levels, the ball can then be pressed into one of the two sides again in order to correspondingly block one or the other group of spray nozzles again, so that an interaction is obtained between the two groups of spray nozzles as the program progresses.

### BRIEF DESCRIPTION OF THE DRAWINGS

An exemplary embodiment of the present invention will be explained in more detail with reference to the following FIGS. 1 through 3, of which:

FIG. 1 is a top view of a nozzle arm showing the ball in the neutral position;

FIG. 2 is a top view of the nozzle arm showing the ball in a first blocking position; and

FIG. 3 is another top view of the nozzle arm showing the ball in a second blocking position.

### DETAILED DESCRIPTION

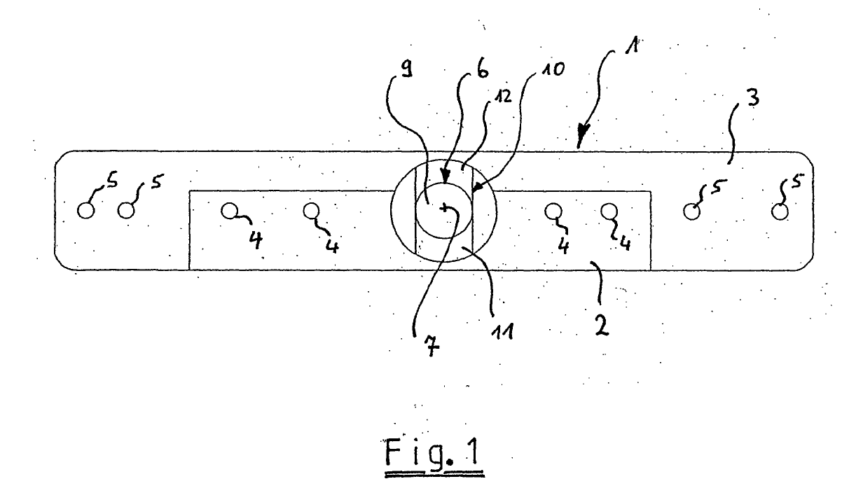

The isolated top views of FIGS. 1 through 3 each show a nozzle arm 1 on which are arranged two groups 2 and 3 of spray nozzles 4 and 5.

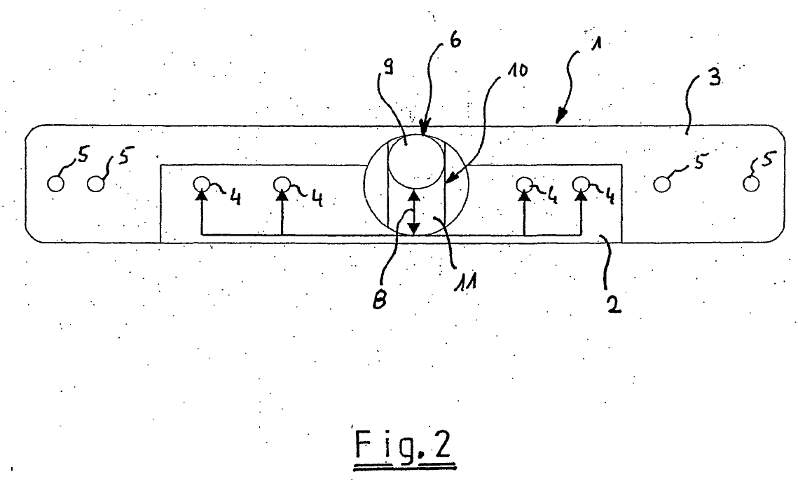

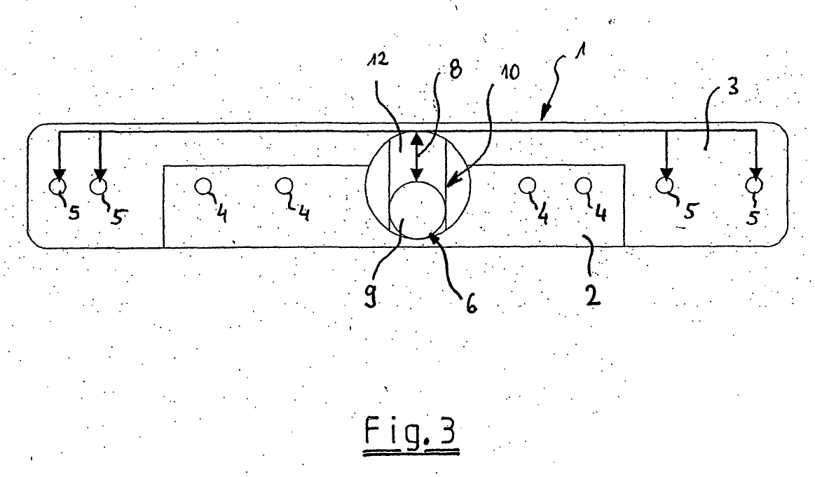

Groups 2 and 3 of spray nozzles 4 and 5 are operated independently by wash water flowing through them. As is apparent when viewing FIGS. 1 through 3 together, a means 6 is disposed in the area of nozzle arm 1, said means enabling either the one group 2 (FIG. 2) or the other group 3 (FIG. 3) of spray nozzles 4 or 5 of nozzle arm 1 for the wash water in a random manner and independently of the control system. As can be seen from FIGS. 2 and 3, the nozzles indicated by arrows according to the position of means 6 are enabled, respectively.

As can be seen from FIG. 1, means 6 is disposed in axis of rotation 7 of nozzle arm 1. More precisely, means 6 is disposed in the wash water supply conduit, which is also provided in axis of rotation 7 of nozzle arm 1.

When viewing FIGS. 1 through 3 together, in particular with respect to arrow 8, which indicates the moving direction of means 6, it can be seen that means 6 assumes different positions. The respective end position is brought about by the pressure of the wash water and/or the rotation of nozzle arm 1 in order to enable one or the other group 2, 3 of spray nozzles 4, 5. For example, in the view of FIG. 2, the inner nozzle group 2 is enabled, while in FIG. 3, the outer nozzle group 3 is enabled. When the circulating pump does not deliver any wash water to the spray system and nozzle arm 1 is at rest, means 6 is located centrally in axis of rotation 7, as shown in FIG. 1.

As can be seen from FIGS. 1 through 3, means 6 preferably includes a ball 9, which is provided in a chamber-like cage 10 through which flows wash water. As can be seen from the top view, groups 2 and 3 of spray nozzles 4 and 5 interact separately with chamber-like cage 10. A depression is provided in chamber-like cage 10 in axis of rotation 7 of nozzle arm 1. A first and second restricted translational guide path 11 and 12 for ball 9 are located on both sides of the depression, respectively. It is apparent from FIGS. 2 and 3 that first guide path 11 is in communication with the one group 2 of spray nozzles 4 while second guide path 12 is in communication with the other group 3 of spray nozzles 5.

As described in greater detail earlier, this results in an arbitrary control mechanism, which, in particular, allows the wash water jets emerging from the two groups 2, 3 to emerge with particular intensity so that the cleaning of the dishes is performed in an alternating manner. This is also because the paths of the spray jets are switched.

1-8. (canceled)

9. A dishwasher comprising:
a circulating pump;
a spraying system disposed in a spray chamber and including a first and a second group of spray nozzles, the first and second group of spray nozzles being disposed on a rotatable nozzle arm, the first and second group of spray nozzles being capable of being operated independently by wash water flowing therethrough; and
a spray nozzle enabling device disposed in an area of the nozzle arm and configured to enable, for the wash water, alternately either the first or the second group of spray nozzles in a random manner and independently of a control system associated with the spraying system.

10. The dishwasher as recited in claim 9 wherein the enabling device is disposed at an axis of rotation of the nozzle arm.

11. The dishwasher as recited in claim 10 wherein the enabling device is disposed in a supply conduit of the wash water.

12. The dishwasher as recited in claim 9 wherein the enabling device is configured to assume a plurality of different positions as a function of at least one of a pressure of the wash water and a rotation of the nozzle arm so as to enable, for the wash water, alternately either the first or the second group of spray nozzles.

13. The dishwasher as recited in claim 11 wherein the enabling device includes a ball disposed in a chamber-like cage configured to have the wash water flow therethrough.

14. The dishwasher as recited in claim 12 wherein the first and the second group of spray nozzles is each connected separately with the chamber-like cage.

15. The dishwasher as recited in claim 14 wherein the chamber-like cage includes a depression at the axis of rotation of the nozzle arm and includes a first and a second restricted translational guide path for the ball each disposed on a respective side of the depression.

16. The dishwasher as recited in claim 15 wherein the first guide path is configured to communicate with the first group of spray nozzles and the second guide path is configured to communicate with the second group of spray nozzles.
